(19) United States
(12) Patent Application Publication
(10) Pub. No.: US 2025/0141153 A1
(43) Pub. Date: May 1, 2025

(54) CONNECTOR

(71) Applicant: SUMITOMO WIRING SYSTEMS, LTD., Mie (JP)

(72) Inventor: Takuya MASUMOTO, Mie (JP)

(21) Appl. No.: 18/924,041

(22) Filed: Oct. 23, 2024

(30) Foreign Application Priority Data
Oct. 31, 2023 (JP) 2023-186473

(51) Int. Cl. H01R 13/627; H01R 13/504; H01R 13/52

(52) U.S. Cl. CPC H01R 13/6272; H01R 13/504; H01R 13/5202

(57) ABSTRACT

A connector 10 includes a housing 20 that is fittable to a counterpart connector 100, and a cover member 60 attached to the housing 20. The housing 20 includes an elastically deformable locking arm 38 that locks the counterpart connector 100, and an opening portion 37 through which the locking arm 38 is exposed on the upper side of the housing 20. The cover member 60 has an upper cover portion 61 covering the opening portion 37 in a state in which the cover member 60 is attached to the housing 20.

### CROSS-REFERENCE TO RELATED APPLICATIONS

This application is based on and claims priority from Japanese Patent Application No. 2023-186473, filed on Oct. 31, 2023, with the Japan Patent Office, the disclosure of which is incorporated herein in its entirety by reference.

### TECHNICAL FIELD

The present disclosure relates to a connector.

### BACKGROUND

A connector disclosed in JP 2006-505113A includes a plug connector housing that is fittable to a cap connector housing. A seal member, which provides a seal between the plug connector housing and the cap connector housing, is attached to the plug connector housing. An elastic latch arm is formed protruding from an upper surface of the plug connector housing. When the elastic latch arm is locked to a latch protrusion of the cap connector housing, the cap connector housing and the plug connector housing are held in a fitted state. The elastic latch arm is exposed on the upper side of the plug connector housing. A CPA (connector position assurance device) is mounted on the cap connector housing to be movable in a front-rear direction. The elastic latch arm is partially covered by the CPA from above. JP 2001-307830A and JP 2016-076407A also disclose connectors provided with members corresponding to the CPA.

### SUMMARY

In JP 2006-505113A, the cap connector housing and the plug connector housing that are in a fitted state are separated from each other in some cases for reasons such as maintenance. During this separation, foreign matter such as sand or mud adhering to the outer surface of the plug connector housing may fall onto and adhere to the seal member. If foreign matter adheres to the seal member, problems may arise, such as required sealing performance not being ensured when the cap connector housing and the plug connector housing are fitted to each other again.

Here, foreign matter such as sand or mud may enter the inside of the plug connector housing through a gap that is not covered by the CPA and is present above the elastic latch arm.

In view of this, the present disclosure aims to provide a connector that can prevent foreign matter from entering the inside of the housing and can maintain the inside of the housing in a state prior to initial fitting.

The connector according to the present disclosure includes a housing that is fittable to a counterpart connector and a cover member attached to the housing, in which the housing includes an elastically deformable locking arm that locks the counterpart connector and an opening portion through which the locking arm is exposed on an upper side of the housing and the cover member has an upper cover portion covering the opening portion in a state in which the cover member is attached to the housing.

According to the present disclosure, it is possible to provide a connector that can prevent foreign matter from entering the inside of the housing and can maintain the inside of the housing in a state prior to initial fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a state in which a cover member is held at an initial position with respect to a housing in a connector of Embodiment 1.

FIG. 2 is a transverse cross-sectional view showing a state in which a retained portion is disposed to be capable of being locked to a retaining portion when the cover member is located at an initial position in the connector of Embodiment 1.

FIG. 3 is a side cross-sectional view showing a state in which a restricting portion is disposed to be capable of being locked to a front surface of a locking hole when the cover member is located at the initial position in the connector of Embodiment 1.

FIG. 4 is a side cross-sectional view showing a state in which the restricting portion is pushed upward by the locking portion of the counterpart housing and the cover member is movable from the initial position to a detection position in the connector of Embodiment 1.

FIG. 5 is a side cross-sectional view showing a state in which the restricting portion is disposed to be capable of being locked to a front end surface of a locking arm when the cover member is located at the detection position in the connector of Embodiment 1.

FIG. 6 is a perspective view showing a state in which the cover member is held at the detection position with respect to the housing in the connector of Embodiment 1.

FIG. 7 is an enlarged rear view showing an upper portion of the connector of Embodiment 1 in a state in which the cover member is held at the detection position with respect to the housing.

FIG. 8 is a transverse cross-sectional view showing a state in which a stopped surface of a narrowed portion is disposed to be able to abut against a stopper surface of an overhang portion when the cover member is located at the detection position in the connector of Embodiment 1.

FIG. 9 is an enlarged side cross-sectional view showing a state in which a rear labyrinth portion is formed between a fitting recess and an opposing wall when the cover member is located at the detection position in the connector of Embodiment 1.

FIG. 10 is a plan view of the housing in the connector of Embodiment 1.

FIG. 11 is a perspective view of the cover member in the connector of Embodiment 1.

FIG. 12 is a front view of the cover member in the connector of Embodiment 1.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A connector according to the present disclosure includes: a housing that is fittable to a counterpart connector; and a cover member attached to the housing, in which the housing includes an elastically deformable locking arm that locks the counterpart connector and an opening portion through which the locking arm is exposed on an upper side of the housing, and the cover member has an upper cover portion covering the opening portion in a state in which the cover member is attached to the housing.

According to the above-mentioned configuration (1), for example, when the connector is separated from the counterpart connector, the upper cover portion of the cover member can prevent foreign matter such as sand or mud adhering to an outer surface of the housing from entering the inside of the housing through the opening portion. Thus, even when the housing and the counterpart connector are re-fitted to each other, the inside of the housing can be maintained in a state prior to initial fitting.

(2) In the connector according to (1) above, it is preferable that the housing is provided with a warpage space that allows a warping operation of the locking arm, the warpage space is open to a rear of the housing, and the cover member has a rear cover portion covering the warpage space in a state in which the cover member is attached to the housing.

According to the above-mentioned configuration (2), the rear cover portion of the cover member can prevent foreign matter adhering to the outer surface of the housing from entering the inside of the housing through the warpage space.

(3) In the connector according to (1) or (2) above, it is preferable that a labyrinth portion bent in an uneven shape is formed between opposing surfaces of the housing and the cover member.

According to the above-mentioned configuration (3), even when a gap is formed between the opposing surfaces of the housing and the cover member, a labyrinth structure of the labyrinth portion can prevent foreign matter from entering the inside of the housing through the gap.

(4) In the connector according to any one of (1) to (3) above, it is preferable that the cover member is a fitting detection member that is attached to the housing to be movable between an initial position and a detection position located forward of the initial position, and is capable of moving to the detection position when the housing and the counterpart connector are properly fitted to each other.

According to the above-described configuration (4), the cover member can be equipped with the function of detecting the fitted state of the connector in addition to the function of preventing foreign matter from entering the inside of the housing.

(5) In the connector according to (4) above, it is preferable that an upper surface of the upper cover portion is provided with a recessed portion, and the recessed portion has inner surfaces including a rear surface located on a rear side and facing forward, and the rear surface is provided with an anti-slip portion.

According to the above-described configuration (5), for example, when separating the housing and the counterpart connector and moving the cover member from the detection position to the initial position, the cover member can be operated by hooking a finger on the anti-slip portion, thus improving operability of the cover member. Also, foreign matter such as sand and mud can be stored in the recessed portion.

(6) In the connector according to (4) or (5) above, it is preferable that a seal member that provides a seal between the housing and the counterpart connector is attached to the housing, and the upper cover portion is disposed to cover the seal member from above, regardless of whether the cover member is located at the initial position or the detection position with respect to the housing.

According to the above-described configuration (6), the upper cover portion of the cover member can prevent foreign matter from adhering to the seal member, regardless of whether the cover member is located at the initial position or the detection position. Thus, it is possible to ensure a required sealing property between the housing and the counterpart connector.

### Details of Embodiments of the Present Disclosure

A specific example of the present disclosure will be described below with reference to the drawings. Note that the present invention is not limited to these examples, and is defined by the claims, and all changes that come within the meaning and scope of equivalency of the claims are intended to be embraced therein.

### Embodiment 1

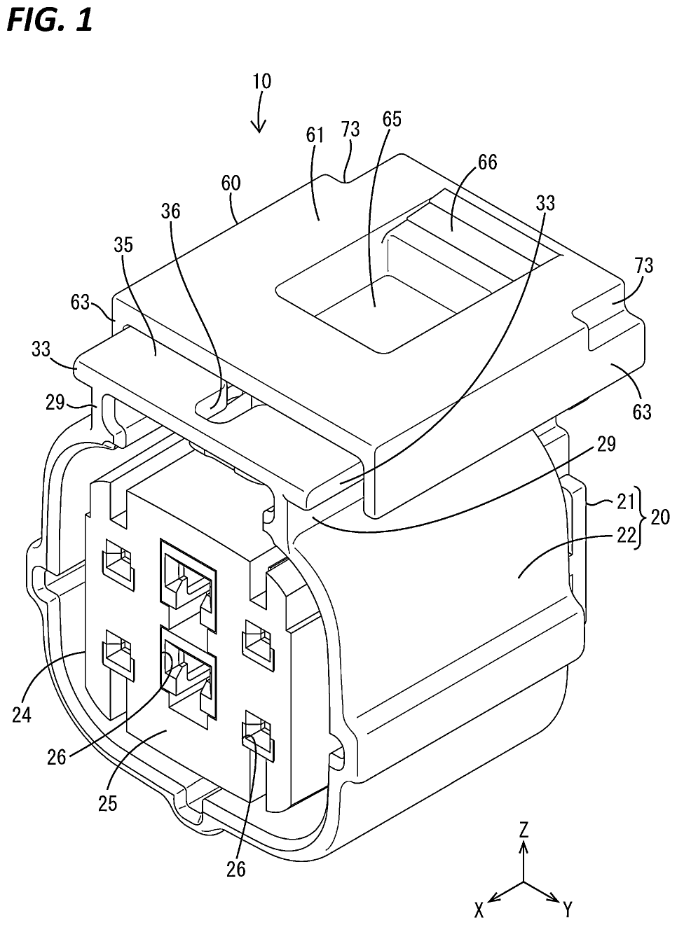

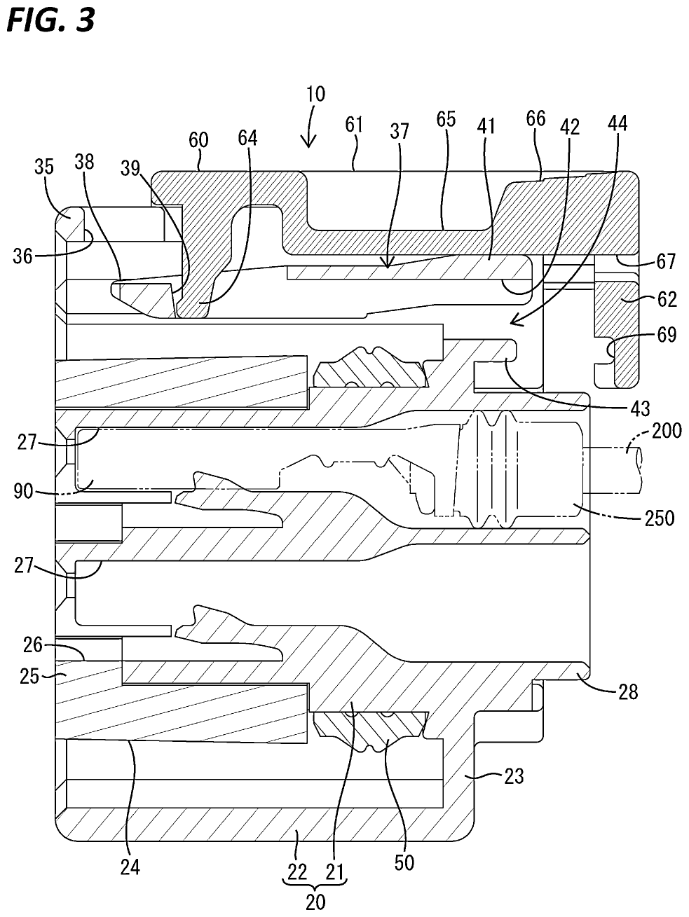

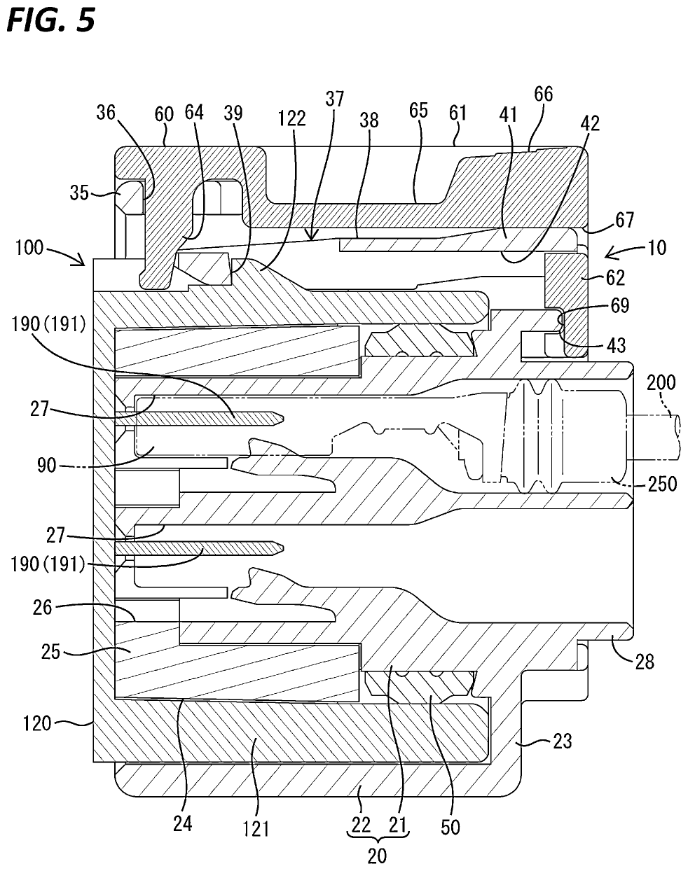

As shown in FIG. 1, a connector 10 of Embodiment 1 includes a housing 20 and a cover member 60 attached to the housing 20. As shown in FIG. 3, a terminal fitting 90 is accommodated in the housing 20. As shown in FIG. 5, the housing 20 is fittable to a counterpart housing 120 of a counterpart connector 100. Note that, in the following description, the side where the housing 20 is fitted to the counterpart housing 120 is referred to as the front side in the front-rear direction. An up-down direction is based on the up-down direction shown in FIG. 1. A left-right direction is based on the left-right direction shown in FIG. 1. In FIG. 1, an arrow X indicates the front-rear direction, an arrow Y indicates the left-right direction, and an arrow Z indicates the up-down direction. The left-right direction is synonymous with the width direction, and the up-down direction is synonymous with the height direction.

### (Housing 20, Terminal Fitting 90)

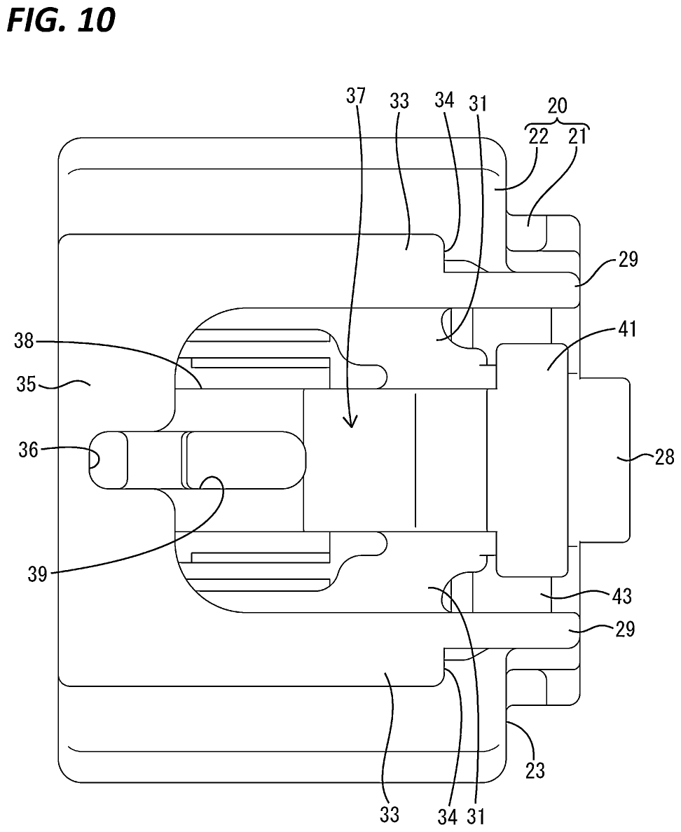

The housing 20 is made of synthetic resin, and includes a housing body 21 and a tubular fitting portion 22 that surrounds an outer periphery of the housing body 21 as shown in FIGS. 3 and 10. The housing body 21 and the tubular fitting portion 22 are linked together via a linking portion 23 extending along a radial direction on the rear side of the housing 20.

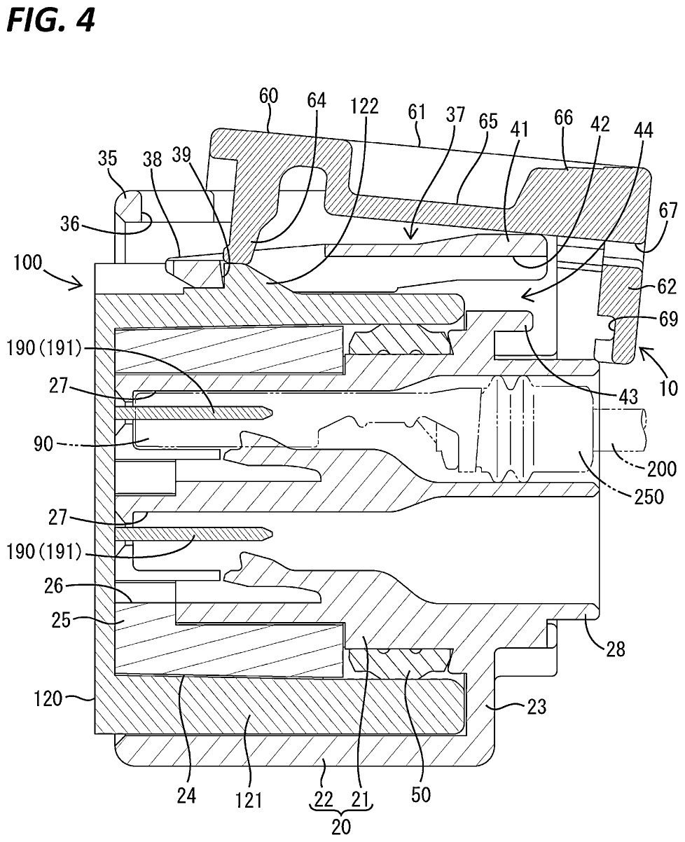

As shown in FIGS. 1 and 3, a front holder 24 is attached to the housing body 21 from the front. The front holder 24 is made of synthetic resin, has a cap shape, and includes a front wall 25 covering a front surface of the housing body 21. A plurality of tab insertion holes 26 extend through the front wall 25 in the front-rear direction. As shown in FIG. 4, tabs 191 of a counterpart terminal fitting 190 attached to the counterpart housing 120 from the front are inserted into the tab insertion holes 26.

A plurality of cavities 27 extend through the housing body 21 in the front-rear direction. The cavities 27 are respectively in communication with the tab insertion holes 26. The terminal fittings 90 are respectively inserted from the rear into and accommodated in the cavities 27.

Each terminal fitting 90 is formed by, for example, bending a metal plate member. As shown in FIGS. 3 to 5, a rear portion of the terminal fitting 90 is electrically and mechanically connected to a terminal portion of a wire 200. A front portion of the terminal fitting 90 receives a tab 191 inserted into the tab insertion hole 26 and is electrically connected to the counterpart terminal fitting 190.

A seal member 50 is attached to the housing body 21. The seal member 50 is made of rubber such as silicon rubber and has a ring shape, and as shown in FIGS. 4 and 5, the seal member 50 comes into intimate contact with an outer peripheral surface of the housing 20 and an inner peripheral surface of a hood portion 121 of the counterpart housing 120 when the housing 20 and the counterpart housing 120 are in a fitted state.

The housing body 21 has a cavity tower portion 28 protruding rearward from the linking portion 23. The cavity tower portion 28 has a cylindrical shape and surrounds rear portions of the cavities 27. A rubber plug 250 attached to the wire 200 is accommodated in the rear portion of each cavity 27. The rubber plug 250 is in intimate contact with the outer peripheral surface of the wire 200 and the inner peripheral surface of the cavity tower portion 28.

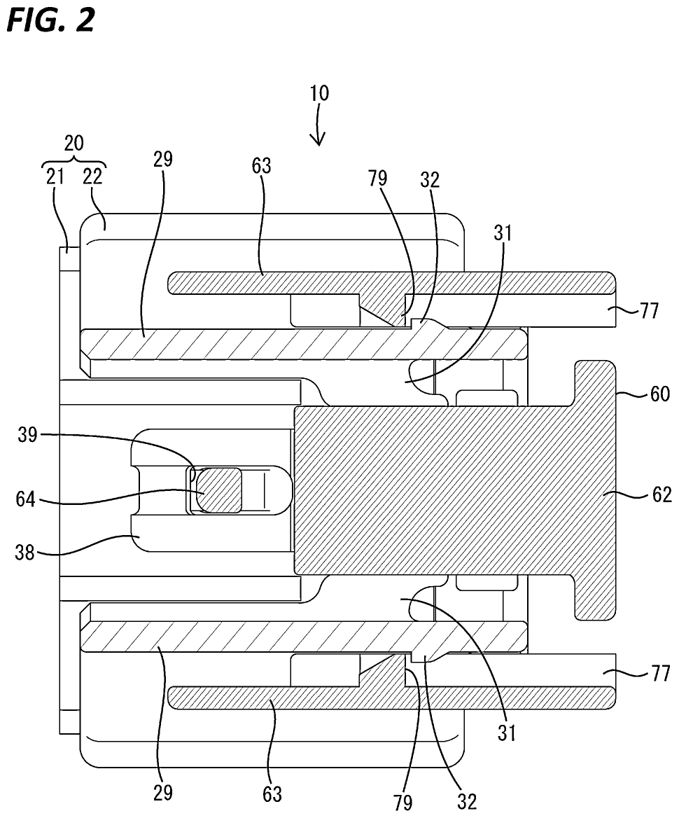

As shown in FIGS. 2, 7, and 10, the upper portion of the tubular fitting portion 22 has a pair of left and right side wall portions 29. The side wall portions 29 face each other at an interval in the left-right direction, and are formed over the entire length of the tubular fitting portion 22 in the front-rear direction. The side wall portions 29 are rectangular plate shaped in a side view and disposed along the front-rear direction.

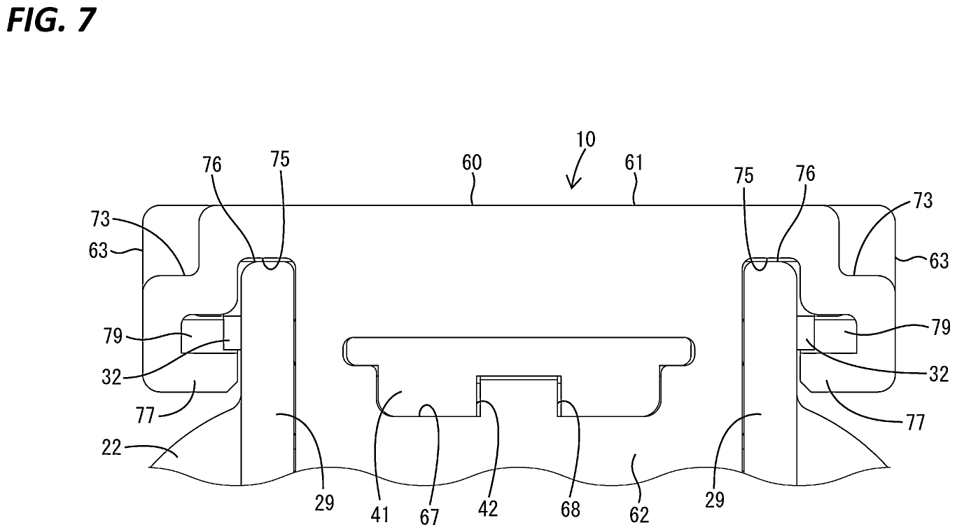

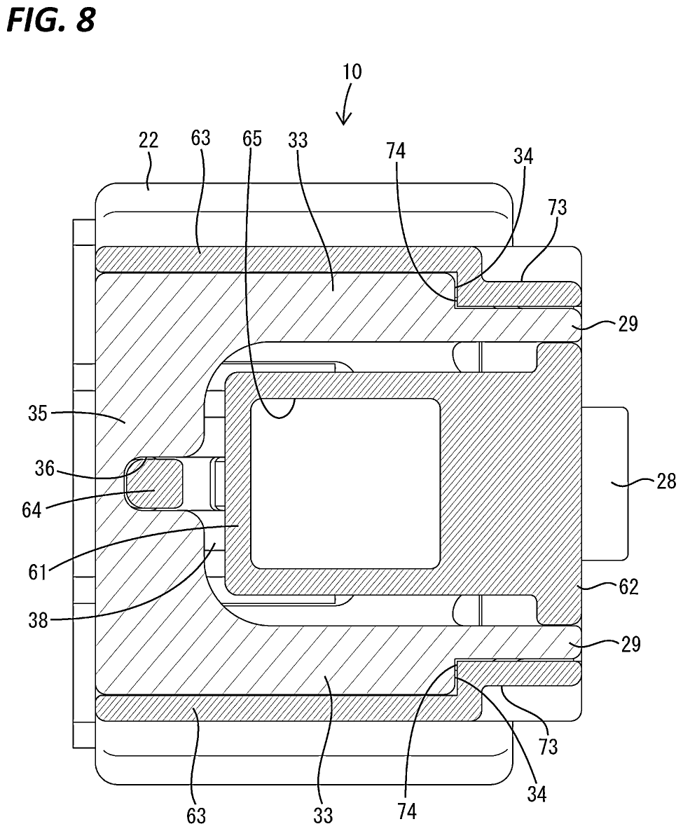

As shown in FIGS. 2 and 7, retaining portions 32 protrude from left and right outer surfaces of the side wall portions 29. Each retaining portion 32 has a small protrusion shape and can be fitted to a later-described retained portion 79 of the cover member 60. As shown in FIG. 1, overhang portions 33 protrude outward respectively from the upper end portions of the side wall portions 29 in the left-right direction. Each overhang portion 33 is rib-shaped, and extends from a front end to a rear end of the side wall portion 29 as shown in FIG. 8. A rear end surface of the overhang portion 33 is a stopper surface 34 that restricts forward movement of the cover member 60. The stopper surfaces 34 are disposed along the left-right direction, and can be locked to later-described stopped surfaces 74 of the cover member 60.

As shown in FIG. 1, the tubular fitting portion 22 has a bridge portion 35 that connects front ends of the side wall portions 29. A cut-out portion 36 is formed in a center portion of the rear end of the bridge portion 35 in the left-right direction. As shown in FIG. 10, an opening portion 37 is formed between the side wall portions 29 and rearward of the bridge portion 35. The opening portion 37 is provided between the side wall portions 29 and above a locking arm 38 and a fulcrum portion 31, which will be described later, and is open rearward from the bridge portion 35.

As shown in FIG. 10, the housing 20 has a locking arm 38 between the side wall portions 29. The locking arm 38 is exposed, except for a portion of its front end portion, to be visible from above through the opening portion 37. As shown in FIGS. 3 and 10, the locking arm 38 has a plate shape extending in the front-rear direction. The locking arm 38 is elastically displaceable (tilting displacement) in the up-down direction in a seesaw-like manner via a pair of left and right fulcrum portions 31 that connect left and right end surfaces of the locking arm 38 to the left and right inner surfaces of the side wall portions 29. A lock hole 39 extends through the locking arm 38 in the up-down direction (the thickness direction of the locking arm 38). As shown in FIG. 5, a locking portion 122 protruding from the upper surface of the hood portion 121 of the counterpart housing 120 is fitted into the lock hole 39 of the locking arm 38. As a result of the locking portion 122 fitting into the lock hole 39, the housing 20 and the counterpart housing 120 are held in a fitted state. The rear end portion of the locking arm 38 is provided with a cancel operation portion 41, which is pressed when canceling a locked state in which the locking arm 38 and the locking portion 122 are locked to each other. As shown in FIG. 10, the cancel operation portion 41 has portions protruding leftward and rightward. A recess 42 is formed in a left-right intermediate portion of the locking arm 38 due to removal of a die (not shown) for forming the lock hole 39. As shown in FIG. 7, the recess 42 is open to a lower surface of the cancel operation portion 41 and is also open to the rear.

As shown in FIGS. 3 and 10, the housing 20 has an opposing wall 43 at a position below the cancel operation portion 41 and where the housing 20 faces the cancel operation portion 41. The opposing wall 43 has a rib shape protruding rearward from the linking portion 23 and extending in the left-right direction. As shown in FIG. 3, a warpage space 44 that allows the locking arm 38 to warp is formed between the cancel operation portion 41 and the opposing wall 43, and is open rearward.

### (Cover Member 60)

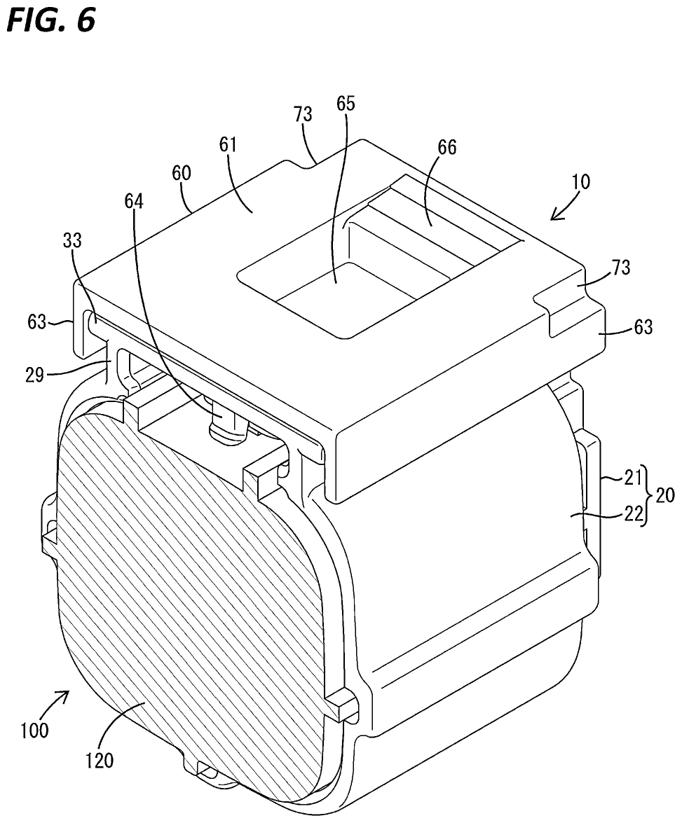

The cover member 60 is made of synthetic resin, and as shown in FIGS. 1, and 3 to 6, is attached to an upper portion of the housing 20 and is disposed to cover the upper and rear sides of the upper portion of the housing 20. In Embodiment 1, the cover member 60 is configured as a fitting detection member that is movable with respect to the housing 20 in the front-rear direction between the initial position and the detection position. The cover member 60 serving as a fitting detection member is configured to be movable from the initial position (the position shown in FIGS. 1 and 3) to the detection position (the position shown in FIGS. 5 and 6) when the housing 20 and the counterpart housing 120 are properly fitted.

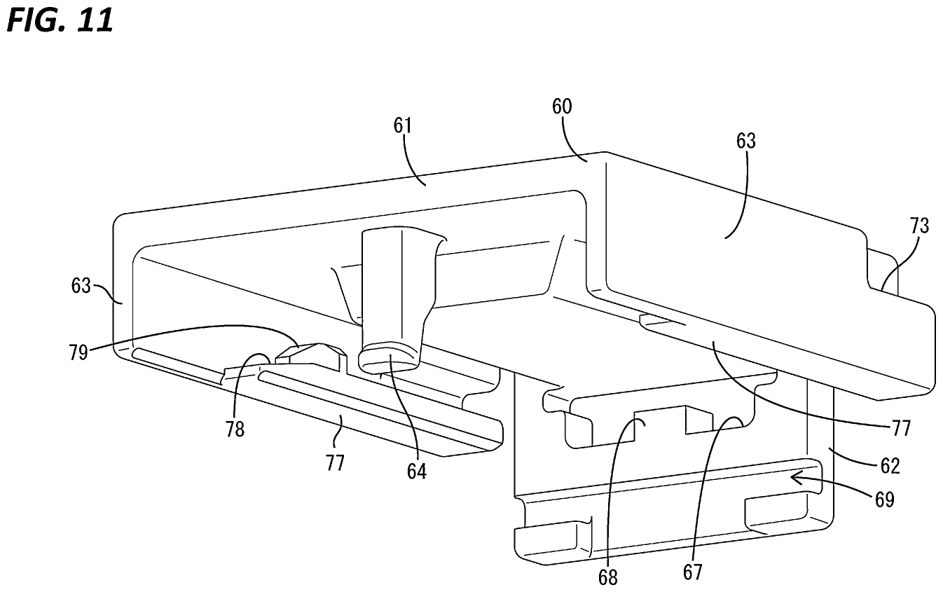

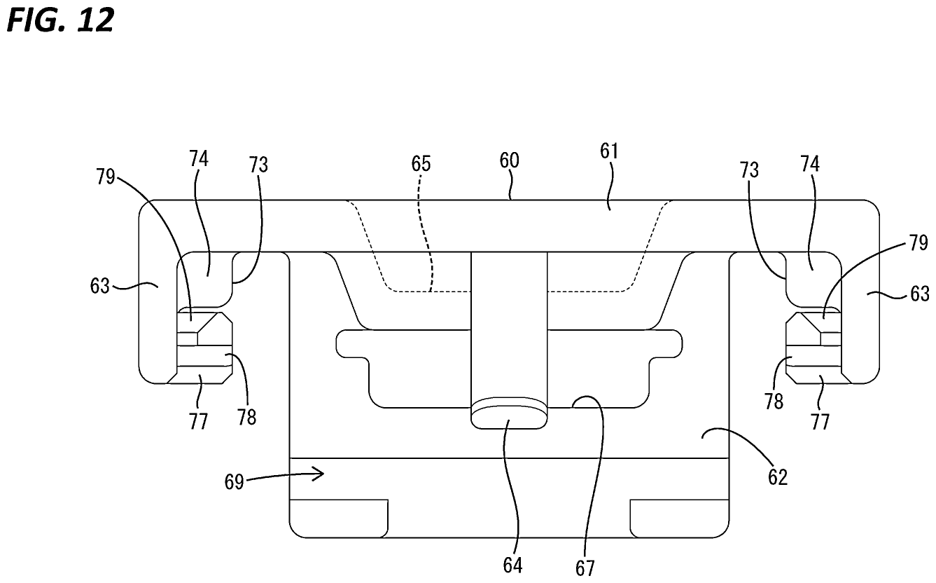

As shown in FIGS. 11 and 12, the cover member 60 includes an upper cover portion 61, a rear cover portion 62 protruding downward from a rear end portion of the upper cover portion 61, a pair of left and right side plate portions 63 protruding downward from the left and right end portions of the upper cover portion 61, and a restricting portion 64 protruding downward from a front end portion of the upper cover portion 61. As will be described later, the restricting portion 64 restricts movement of the cover member 60.

The upper cover portion 61 has a rectangular outer shape in a plan view (see FIGS. 1 and 6) and is disposed to cover the opening portion 37 of the housing 20 from above (see FIGS. 3 to 5). As shown in FIGS. 1 and 6, the upper cover portion 61 has a recessed portion 65 formed by recessing a center portion of the upper surface of the upper cover portion 61. The recessed portion 65 has a rectangular opening shape in a plan view. The recessed portion 65 has inner surfaces including a rear surface located on the rear side and facing forward, and the rear surface is provided with an anti-slip portion 66. The anti-slip portion 66 has a step shape rising rearward like steps. A rear end of the anti-slip portion 66 is located near the rear end of the cover member 60. As shown in FIG. 12, the lower surface of the upper cover portion 61 protrudes downward by a protruding amount corresponding to the depth (the amount of recess) of the recessed portion 65.

The rear cover portion 62 has a rectangular outer shape in a front view (see FIG. 12) and is disposed to cover the upper portion of the housing 20 including the warpage space 44 from the rear (see FIGS. 3 to 5). As shown in FIG. 7, the rear cover portion 62 has a fitting hole 67 to which the cancel operation portion 41, which is the rear end portion of the locking arm 38, is fittable, at the detection position. The fitting hole 67 has a protrusion 68 at a position corresponding to the position of the recess 42 of the cancel operation portion 41 (see FIG. 11).

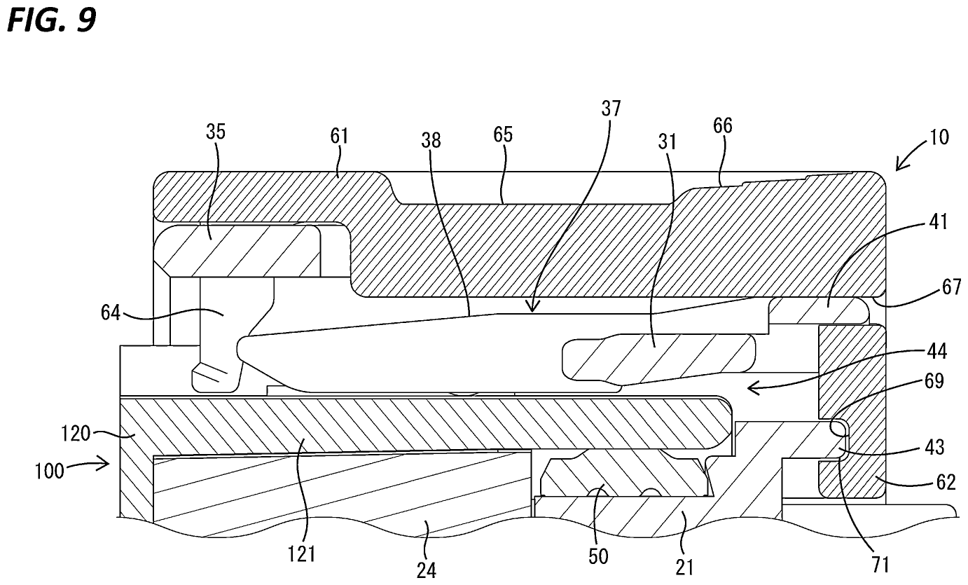

As shown in FIGS. 11 and 12, a fitting recess 69 is provided in a lower end portion of the front surface of the rear cover portion 62 over the entire length in the left-right direction. A portion of the fitting recess 69 other than the left and right end portions is open forward and downward. The left and right end portions of the fitting recess 69 each form a C-shape with corners, is open forward in a side view, and closed at the bottom. As shown in FIG. 9, the opposing wall 43 is fitted into the fitting recess 69 at the detection position. A rear labyrinth portion 71 is formed, as a labyrinth portion bent in an uneven shape, between the left and right end portions of the fitting recess 69 and the opposing wall 43 fitted therein.

As shown in FIG. 11, each side plate portion 63 has a rectangular shape in a side view, elongate in the front-rear direction. As shown in FIGS. 6 and 7, each side plate portion 63 is provided with a narrowed portion 73 recessed inward in the left-right direction from the outer surface of the rear end portion of the side plate portion 63. As shown in FIG. 8, of the outer surface of the narrowed portion 73 facing the protruding side of the narrowed portion 73, a front surface portion located at the front end and facing forward serves as a stopped surface 74 that can come into contact with the stopper surface 34 at the detection position.

As shown in FIG. 7, at left and right end portions on the rear side of the cover member 60, a fitting portion 75 is formed in a gate shape in a back view, and is defined by left and right inner surfaces located on the left and right inner sides of the outer surface on the protruding side of the narrowed portion 73, an inner lower surface of the upper cover portion 61 that is connected to the upper ends of the left and right inner surfaces, and left and right outer surfaces of the rear cover portion 62 that is connected to the left and right inner ends of the inner lower surface. A portion of the upper end portion of the side wall portion 29 rearward of the overhang portion 33 is fitted into the inside of the fitting portion 75. An upper labyrinth portion 76 is formed, as a labyrinth portion bent in an uneven shape, between the fitting portion 75 and the side wall portion 29.

As shown in FIGS. 11 and 12, each side plate portion 63 has an extension portion 77 protruding inward in the left-right direction from the lower end portion of the side plate portion 63. The extension portion 77 has a rib shape that extends forward from the rear end of the side plate portion 63. As shown in FIG. 11, a front end portion of the upper surface of the extension portion 77 is provided with an inclined portion 78, which is inclined downward toward a leading end. Also, each side plate portion 63 has a retained portion 79 protruding from a portion of the upper surface of the extension portion 77 that is connected to the rear end of the inclined portion 78. The retained portion 79 has a small protrusion shape and is disposed to be capable of being locked to the retaining portion 32 at the initial position (see FIG. 2).

The restricting portion 64 extends in the up-down direction, and protrudes downward from a center portion in the left-right direction of the lower surface located slightly rearward of the front end of the upper cover portion 61. At the initial position, the front surface of the restricting portion 64 faces, from the rear, the front surface of the lock hole 39 of the locking arm 38 (the surface located in front of the lock hole 39 and facing rearward). As a result of the restricting portion 64 coming into contact with the front surface of the lock hole 39 of the locking arm 38, movement of the cover member 60 from the initial position toward the forward detection position is restricted. At the detection position, the rear surface of the restricting portion 64 faces, from the front, the front end surface of the locking arm 38. As a result of the restricting portion 64 coming into contact with the front end surface of the locking arm 38, movement of the cover member 60 from the detection position toward the initial position is restricted.

### (Effects of Connector 10)

The cover member 60 is disposed rearward of and above the housing 20, and attached to the housing 20 in a state in which the cover member 60 is tilted forward and downward. In the process of attaching the cover member 60, the extension portion 77 slides along the lower surface side of the overhang portion 33 while being guided by the inclined portion 78, and the restricting portion 64 is inserted into the lock hole 39 from above. When the cover member 60 reaches the initial position with respect to the housing 20, as shown in FIG. 3, the restricting portion 64 is disposed to be able to come into contact with the front surface of the lock hole 39, and further forward movement of the cover member 60 is restricted. Also, as shown in FIG. 2, the retained portion 79 faces the retaining portion 32 to be able to come into contact with the retaining portion 32 from the front, and the cover member 60 is kept from coming off rearward.

As shown in FIG. 1, at the initial position, the upper cover portion 61 is placed on the upper surfaces of the overhang portions 33 and the side wall portions 29, and the side plate portions 63 faces the left and right outer surfaces of the overhang portions 33. The opening portion 37 is entirely covered and closed by the upper cover portion 61. Also, as shown in FIG. 3, the rear cover portion 62 is disposed rearward of the warpage space 44. The warpage space 44 becomes invisible from the rear due to the rear cover portion 62.

The terminal fittings 90 are inserted from the rear into the cavities 27 of the housing 20 in a state in which the terminal fitting 90 is connected to the terminal portion of the wire 200, and accommodated in the cavity 27. After all of the terminal fittings 90 have been accommodated in the housing 20, the housing 20 is fitted to the counterpart housing 120. In the process of fitting the housing 20 and the counterpart housing 120, the front end portion of the locking arm 38 interferes with the locking portion 122, causing the locking arm 38 to be elastically deformed downward. Thereafter, the front surface of the housing 20 reaches the position where it comes into contact with the back surface of the hood portion 121 of the counterpart housing 120, resulting in a state in which the housing 20 and the counterpart housing 120 are properly fitted to each other. As shown in FIG. 4, as the housing 20 and the counterpart housing 120 are properly fitted to each other, the locking arm 38 is displaced in a returning direction, and the locking portion 122 is fitted to the lock hole 39 from below. Accordingly, the restricting portion 64 is pushed up by the locking portion 122, and the locked state of the restricting portion 64 with respect to the locking arm 38 is canceled. At this time, the entire cover member 60 become tilted upward and forward in a range in which the overhang portion 33 can be tilted between the upper cover portion 61 and the extension portion 77.

Thereafter, the cover member 60 is moved (proceeds) toward the detection position. When the restricting portion 64 moves over the front end portion of the locking arm 38, the cover member 60 returns to its original orientation. As shown in FIG. 5, when the cover member 60 reaches the detection position, the restricting portion 64 faces the front end portion of the locking arm 38 from the front side to be able to come into contact with the front end portion, and rearward movement of the cover member 60 (toward the initial position) is restricted. As shown in FIG. 8, the restricting portion 64 is fitted into the cut-out portion 36 in a positioned state. Also, at the detection position, the stopped surfaces 74 of the narrowed portions 73 face the stopper surfaces 34 of the overhang portions 33 from the rear to be able to come into contact therewith (see FIG. 8), and the back surface of the fitting recess 69 faces the rear end surface of the opposing wall 43 from the rear to be able to come into contact therewith (see FIG. 9). This also restricts forward movement of the cover member 60 at the detection position.

In the above description, the rear end portion of the opposing wall 43 is fitted to the left and right end portions of the fitting recess 69, thus forming the rear labyrinth portion 71 bent in an uneven shape, between the left and right end portions of the fitting recess 69 and the opposing wall 43 (see FIG. 9). Also, the upper end portion of each side wall portion 29 is fitted into the fitting portion 75 of the narrowed portion 73, thus forming the upper labyrinth portion 76 bent in an uneven shape, between the side wall portion 29 and the fitting portion 75 (see FIG. 7).

At the detection position, as shown in FIGS. 5 and 6, the upper cover portion 61 is disposed to cover the entire upper surface of the housing 20 including the bridge portion 35. The rear cover portion 62 is disposed above the cavity tower portion 28 and sandwiched in the left-right direction between the rear end portions of the side wall portions 29 (see FIG. 7). As shown in FIG. 7, the cancel operation portion 41 is fitted into the fitting hole 67 of the rear cover portion 62, and the protrusion 68 is fitted into the recess 42. As shown in FIGS. 5, 8, and 9, the upper space of the housing 20 including the warpage space 44 is covered and closed by the rear cover portion 62. Also, the rear cover portion 62 is positioned above the housing 20 by the cancel operation portion 41 fitted into the fitting hole 67.

If the housing 20 is not properly fitted to the counterpart housing 120, the locking portion 122 will not fit into the lock hole 39, and the restricting portion 64 will be kept facing the front surface of the lock hole 39 to be capable of coming into contact therewith. Thus, even when the cover member 60 is pressed forward, the cover member 60 cannot move toward the detection position and remains at the initial position. Therefore, based on the cover member 60 becoming movable to the detection position, it can be determined (detected) that the housing 20 is properly fitted to the counterpart housing 120.

In the above state, the connector 10 is mounted in a vehicle (not shown) or the like and used. In the state in which the connector 10 is mounted in a vehicle or the like, foreign matter such as sand or mud may adhere to the connector 10. Here, foreign matter that comes into contact with the upper portion of the connector 10 will adhere to the outer surface of the cover member 60, and thus will be prevented from entering the inside of the housing 20 through the opening portion 37 and the warpage space 44.

Even when foreign matter is to enter a gap between the upper portion of the housing 20 and the cover member 60, in Embodiment 1, the labyrinth structure of the upper labyrinth portion 76 and the rear labyrinth portion 71 makes it difficult for foreign matter to enter the gap, and thus foreign matter is reliably prevented from entering the inside of the housing 20. Also, foreign matter can be stored in the recessed portion 65 of the upper cover portion 61.

When the housing 20 and the counterpart housing 120 are to be separated for reasons such as maintenance, a finger is hooked on the anti-slip portion 66 of the recessed portion 65, and the rear end portion of the cover member 60 is pulled slightly rearward and then pushed downward. Then, the cover member 60 is tilted upward and forward, the locked state of the restricting portion 64 with respect to the locking arm 38 is canceled, and the cover member 60 becomes movable toward the initial position. Further, the anti-slip portion 66 is pressed rearward, and the cover member 60 is moved (retracted) toward the initial position. Also, the cancel operation portion 41 is pressed by the cover member 60 and displaced into the warpage space 44, and the locked state of the locking arm 38 with respect to the locking portion 122 is also canceled. This allows the housing 20 to be separated from the counterpart housing 120. When the cover member 60 reaches the initial position, as described above, the restricting portion 64 is fitted into the lock hole 39, releasing the inclination of the cover member 60.

When the cover member 60 is located at the detection position and the initial position, or when the cover member 60 moves between the detection position and the initial position, the upper side of the seal member 50 is always covered by the upper cover portion 61 of the cover member 60. This prevents foreign matter from falling onto the seal member 50 from above. Also, since the opening portion 37 is kept covered by the upper cover portion 61 and the warpage space 44 is kept covered by the rear cover portion 62, foreign matter is always prevented from entering the inside of the housing 20.

The housing 20 can be separated from the counterpart housing 120 and then fitted to the counterpart housing 120 again. At this time, as described above, the cover member 60 makes it difficult for foreign matter to enter the inside of the housing 20. Thus, a state similar to that before the initial fitting can be maintained. Therefore, the housing 20 and the counterpart housing 120 can be re-fitted to each other without any hindrance.

As described above, the connector 10 of Embodiment 1 includes the housing 20 that is fittable to the counterpart housing 120 of the counterpart connector 100, and the cover member 60 attached to the housing 20. The housing 20 includes an elastically deformable locking arm 38 that locks the counterpart housing 120, and the opening portion 37 through which the locking arm 38 is exposed on the upper side of the housing 20. Also, the cover member 60 has the upper cover portion 61 covering the opening portion 37 in a state in which the cover member 60 is attached to the housing 20. According to this, when the connector 10 is separated from the counterpart connector 100, the upper cover portion 61 of the cover member 60 can prevent foreign matter such as sand or mud adhering to the outer surface of the housing 20 from entering the inside of the housing 20 through the opening portion 37. Thus, even when the housing 20 and the counterpart housing 120 are re-fitted to each other, the inside of the housing 20 can be maintained in a state prior to the initial fitting.

Also, in Embodiment 1, the housing 20 is provided with the warpage space 44 that allows a warping operation of the locking arm 38, and the warpage space 44 is open to the rear of the housing 20. Then, the cover member 60 has the rear cover portion 62 covering the warpage space 44 in a state in which the cover member 60 is attached to the housing 20. According to this, the rear cover portion 62 of the cover member 60 can prevent foreign matter adhering to the outer surface of the housing 20 from entering the inside of the housing 20 through the warpage space 44.

Also, in Embodiment 1, the upper labyrinth portion 76 and the rear labyrinth portion 71 are formed, as labyrinth portions bent in an uneven shape, between the opposing surfaces of the housing 20 and the cover member 60. According to this, even when a gap is formed between the opposing surfaces of the housing 20 and the cover member 60, the labyrinth structure of the upper labyrinth portion 76 and the rear labyrinth portion 71 can prevent foreign matter from entering the inside of the housing 20 through the gap.

Further, in Embodiment 1, the cover member 60 is a fitting detection member that is attached to the housing 20 to be movable between the initial position and the detection position located forward of the initial position, and can move to the detection position when the housing 20 and the counterpart housing 120 are properly fitted to each other. According to this, the cover member 60 can be equipped with the function of detecting the fitted state of the connector 10 in addition to the function of preventing foreign matter from entering the inside of the housing.

Also, in Embodiment 1, the recessed portion 65 is formed in the upper surface of the upper cover portion 61, and the uneven anti-slip portion 66 is formed on the rear surface of the recessed portion 65. According to this, when separating the housing 20 and the counterpart housing 120 and moving the cover member 60 from the detection position to the initial position, the cover member 60 can be operated by hooking a finger on the anti-slip portion 66, thus improving operability of the cover member 60. Also, foreign matter such as sand and mud can be stored in the recessed portion 65.

Further, in Embodiment 1, the seal member 50, which provides a seal between the housing 20 and the counterpart housing 120, is attached to the housing 20, and the upper cover portion 61 is disposed to cover the seal member 50 from above, regardless of whether the cover member 60 is located at the initial position or the detection position with respect to the housing 20. According to this, regardless of whether the cover member 60 is located at the initial position or the detection position, the upper cover portion 61 of the cover member 60 can prevent foreign matter from falling from above and adhering to the seal member 50. Thus, it is possible to ensure a required sealing property between the housing 20 and the counterpart housing 120.

### Other Embodiments of the Present Disclosure

Embodiment 1 disclosed herein is to be considered in all respects as illustrative and not restrictive.

In Embodiment 1, the cover member 60 is configured as a fitting detection member that is movable with respect to the housing 20 between the initial position and the detection position. In contrast, according to other embodiments, the cover member may be attached to the housing without being temporarily locked at the initial position, and may not have a fitting detection function. For example, the cover member may be a dedicated cover member having an upper cover portion or the like, or may be a wire cover having a portion surrounding the wire together with an upper cover portion or the like.

In Embodiment 1, the cover member 60 has the upper cover portion 61 and the rear cover portion 62. In contrast, according to other embodiments, it is sufficient that the cover member has at least the upper cover portion, and the cover member does not need to have the rear cover portion.

In Embodiment 1, the labyrinth portion is constituted by the upper labyrinth portion 76 and the rear labyrinth portion 71. In contrast, according to other embodiments, the labyrinth portion may be constituted by only one of the upper labyrinth portion and the rear labyrinth portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing that is fittable to a counterpart connector; and
a cover member attached to the housing,
wherein the housing includes an elastically deformable locking arm that locks the counterpart connector and an opening portion through which the locking arm is exposed on an upper side of the housing, and
the cover member has an upper cover portion covering the opening portion in a state in which the cover member is attached to the housing.

2. The connector according to claim 1,
wherein the housing is provided with a warpage space that allows a warping operation of the locking arm, and the warpage space is open to a rear of the housing, and
the cover member has a rear cover portion covering the warpage space in a state in which the cover member is attached to the housing.

3. The connector according to claim 1,
wherein a labyrinth portion bent in an uneven shape is formed between opposing surfaces of the housing and the cover member.

4. The connector according to claim 3,
wherein the cover member is a fitting detection member that is attached to the housing to be movable between an initial position and a detection position located forward of the initial position, and is capable of moving to the detection position when the housing and the counterpart connector are properly fitted to each other.

5. The connector according to claim 4,
wherein an upper surface of the upper cover portion is provided with a recessed portion, and
the recessed portion has inner surfaces including a rear surface located on a rear side and facing forward, and the rear surface is provided with an anti-slip portion.

6. The connector according to claim 4,
wherein a seal member that provides a seal between the housing and the counterpart connector is attached to the housing, and
the upper cover portion is disposed to cover the seal member from above, regardless of whether the cover member is located at the initial position or the detection position with respect to the housing.
